(19) United States
(12) Patent Application Publication
(10) Pub. No.: US 2021/0180958 A1
(43) Pub. Date: Jun. 17, 2021

(54) GRAPHIC INFORMATION POSITIONING SYSTEM FOR RECOGNIZING ROADSIDE FEATURES AND METHOD USING THE SAME

(71) Applicant: AUTOMOTIVE RESEARCH & TESTING CENTER, Lugang (TW)

(72) Inventor: RONG-TERNG JUANG, LUGANG (TW)

(21) Appl. No.: 16/715,148

(22) Filed: Dec. 16, 2019

(51) Int. Cl. G01C 21/30; G06K 9/00; G06T 7/73; G01C 21/00

(52) U.S. Cl. CPC G01C 21/30; G06K 9/00651; G06T 7/73; B64C 39/024; G06T 2207/30252; G06T 2207/10032; G01C 21/005

(57) ABSTRACT

A graphic information positioning system for recognizing roadside features and a method using the same is disclosed. The method overlooks a road to establish a road imaging map that includes featured points. A driving environment around a vehicle is detected to obtain a point-cloud map when the vehicle runs. The method determines whether the point-cloud map includes the featured points, filters out dynamic objects, sets featured attributes of roadside featured points, and establishes positioning graphic information according to the road imaging map, the remains of the featured points of the point-cloud map, and the featured attributes. When the vehicle runs, the method recognizes at least two roadside featured points in front of the vehicle as reference points to calculate a moving-vehicle heading angle, thereby calculating the position of the moving vehicle.

### BACKGROUND OF THE INVENTION

### Field of the Invention

The present invention relates to the positioning technology, particularly to a graphic information positioning system for recognizing roadside features and a method using the same.

### Description of the Related Art

A self-driving car, also known as an autonomous vehicle (AV), is a vehicle that is capable of sensing its environment and moving safely with little or no human input. Self-driving cars combine a variety of sensors to perceive their surroundings, such as radar, lidar, sonar, computer vision, and inertial measurement units. Advanced control systems interpret sensory information to identify appropriate navigation paths, as well as obstacles and relevant signage.

The common methods for positioning vehicles include a triangulation method, a simultaneous localization and mapping (SLAM) technology, a tag positioning method, and a fingerprint based map. The triangulation method needs to measure distances among an object and three reference points whose positions are known and obtain intersections of three circles whose centers are the reference points. However, the triangulation method has three or more reference points and lower positioning precision rather than heading information. The SLAM uses lidars to scan a point-cloud map for a driving path and estimate the position of a vehicle based on point-cloud matching. Nevertheless, establishing the point-cloud map is very time-consuming. The point-cloud map has a very high data volume. For example, the point-cloud map has 150 MB per kilometer. In an environment with less point-cloud features, the vehicle is not positioned using the SLAM. Thus, a differential global positioning system (DGPS) and a vehicle steering dynamic model are needed to correct the absolute heading direction of the vehicle. Based on trigonometric function, the tag positioning method uses lidars to scan tags at known points to derive the position of the vehicle. For example, the coordinate of a known bus stop is (x, y), the distance between the bus stop and the vehicle is d, an inclined angle is θ, and the position of the vehicle is (x-d sin θ, y-d cos θ). However, the technology also needs a DGPS and a vehicle steering dynamic model to correct the absolute heading direction of the vehicle. Besides, the arrangement of tags is difficultly established since the tags are easily shielded by street trees, pedestrians, or other obstructions. For the fingerprint based map, a first vehicle uses lidars to scan a point-cloud map for a driving path and a second vehicle estimates the position of the vehicle based on point-cloud matching. However, establishing the point-cloud map is time-consuming Although the data volume of the fingerprint based map is less than that of the SLAM, the fingerprint based map encodes data step by step and thus needs a larger operation volume. In an environment with less point-cloud features, the technology does also not position the vehicle.

To overcome the abovementioned problems, the present invention provides a graphic information positioning system for recognizing roadside features and a method using the same.

### SUMMARY OF THE INVENTION

The primary objective of the present invention is to provide a graphic information positioning system for recognizing roadside features and a method using the same, which overlook a load to obtain a road imaging map, retrieve the point-cloud map of a driving planar environment, use the space superposed technology to rapidly divide the road imaging map into a road space and a roadside space and obtain the space information for specific objects, filter out dynamic objects not required, use static objects remaining as roadside featured points, and establish positioning graphic information with high precision and less data volume.

Another objective of the present invention is to provide a graphic information positioning system for recognizing roadside features and a method using the same, which use a drone to retrieve a road imaging map and use a high-resolution camera to capture low-cost aerial photographs, thereby obtaining a high-precision road map.

Further objective of the present invention is to provide a graphic information positioning system for recognizing roadside features and a method using the same, which use roadside featured points as reference points to calculate the heading angle of a moving vehicle, thereby precisely positioning the moving vehicle.

To achieve the abovementioned objectives, the present invention provides a graphic information positioning method for recognizing roadside features comprising: using at least one first detector to overlook and detect a road, thereby establishing a road imaging map, wherein the road imaging map includes a plurality of featured points; installing at least one second detector on at least one moving vehicle to detect a driving environment around the at least one moving vehicle to obtain a point-cloud map when the at least one moving vehicle runs, using the at least one second detector to determine whether the point-cloud map includes the plurality of featured points, filter out at least one dynamic object of the plurality of featured points, set featured attributes of a plurality of roadside featured points, and establish positioning graphic information according to the road imaging map, the remains of the plurality of featured points of the point-cloud map, and the featured attributes; storing the positioning graphic information into the at least one moving vehicle, using a graphic information positioning system installed in the at least one moving vehicle to scan a front road and recognize at least two roadside featured points of the plurality of roadside featured points according to the positioning graphic information when the at least one moving vehicle runs, and using the positioning graphic information to calculate a moving-vehicle heading angle based on the at least two roadside featured points as reference points; and using the moving-vehicle heading angle and the at least two roadside featured points to calculate a position of the moving vehicle.

In an embodiment of the present invention, a method of establishing the positioning graphic information further comprises: overlaying the road imaging map with the point-cloud map to recognize a road space and at least one roadside space; filtering out the at least one dynamic object of the plurality of featured points and a plurality of static objects of the plurality of featured points remaining as the plurality of roadside featured points; setting the featured attributes of the plurality of roadside featured points; and establishing the positioning graphic information according to a superposed map of overlaying the road imaging map with the point-cloud map, the plurality of roadside featured points, and the featured attributes.

In an embodiment of the present invention, the at least one roadside space, divided into at least two of a sidewalk, a bicycle lane, and an overhang of a storefront from inside to outside, includes a first roadside space and a second roadside space. The featured attributes include latitudes, longitudes, shapes, sizes, and heights.

In an embodiment of the present invention, the at least one moving vehicle captures a roadside image when the at least one moving vehicle runs, the at least one moving vehicle recognizes at least one target object, and the graphic information positioning system of the at least one moving vehicle determines whether the at least one target object is one of the plurality of roadside featured points according to the featured attributes of the positioning graphic information.

The present invention also provides a graphic information positioning system installed in an on-board system of a moving vehicle. The system positions the moving vehicle and comprises: a database storing positioning graphic information, which includes a plurality of roadside featured points and the featured attributes of the plurality of roadside featured points; a roadside featured recognition module scanning a front road and determining at least two roadside featured points of the plurality of roadside featured points corresponding to the featured attributes according to the positioning graphic information; a moving-vehicle heading angle estimation module calculating a moving-vehicle heading angle based on the at least two roadside featured points as reference points; and a moving-vehicle position estimation module using the moving-vehicle heading angle and the at least two roadside featured points to calculate the position of the moving vehicle.

Below, the embodiments are described in detail in cooperation with the drawings to make easily understood the technical contents, characteristics and accomplishments of the present invention.

### BRIEF DESCRIPTION OF THE DRAWINGS

FIG. 1 is a flowchart of a graphic information positioning method for recognizing roadside features according to an embodiment of the present invention;

FIG. 2 is a flowchart of a method of establishing positioning graphic information according to an embodiment of the present invention;

FIGS. 3A-3D are diagrams illustrating of a method of establishing positioning graphic information according to an embodiment of the present invention;

FIG. 4 is a diagram illustrating of a graphic information positioning system according to an embodiment of the present invention;

FIG. 5 is a flowchart of a method for using positioning graphic information to recognize roadside featured points according to an embodiment of the present invention; and

FIG. 6 is a diagram of schematically illustrating the heading angle and the position of a moving vehicle according to an embodiment of the present invention.

### DETAILED DESCRIPTION OF THE INVENTION

The present invention provides a graphic information positioning system for recognizing roadside features and a method using the same, which overlook a road to obtain a road imaging map with high precision, overlays the road imaging map with a point-cloud map around a moving vehicle, rapidly positions a road space and a roadside space, filter out dynamic objects not required, and use remaining static objects, thereby greatly reducing the data volume of positioning graphic information. The present invention uses only two reference points to calculate the position of the vehicle rather than uses a triangulation method, thereby greatly reducing the operation complexity. Applied to positioning an autonomous vehicle, the precision of the present invention reaches a range of 1-10 centimeters. The precision of the conventional global positioning system has an error range of 1-2 meters. Compared with the global positioning system, the precision of the present invention may be still accepted. Thus, the method for using the positioning graphic information of the present invention may guarantee the precision and safety of the autonomous vehicle.

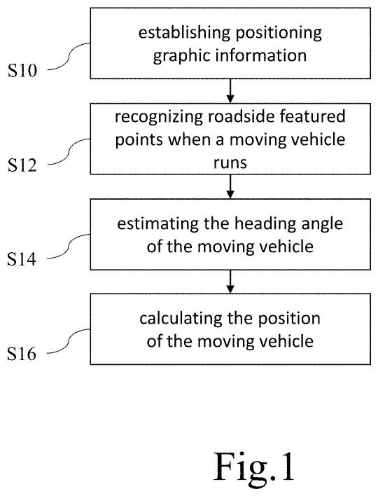

Referring to FIG. 1, the graphic information positioning method comprises four steps, including those of Step S10, Step S12, Step S14, and Step S16. In Step S10, the positioning graphic information is established and provided to a moving vehicle (e.g., an autonomous vehicle) for using. In Step S12, roadside featured points are recognized when the moving vehicle drives. In Step S14, the position of the moving vehicle begins to be corrected to estimate the heading angle of the moving vehicle. In Step S16, the position of the moving vehicle is calculated. These steps are detailed as follows.

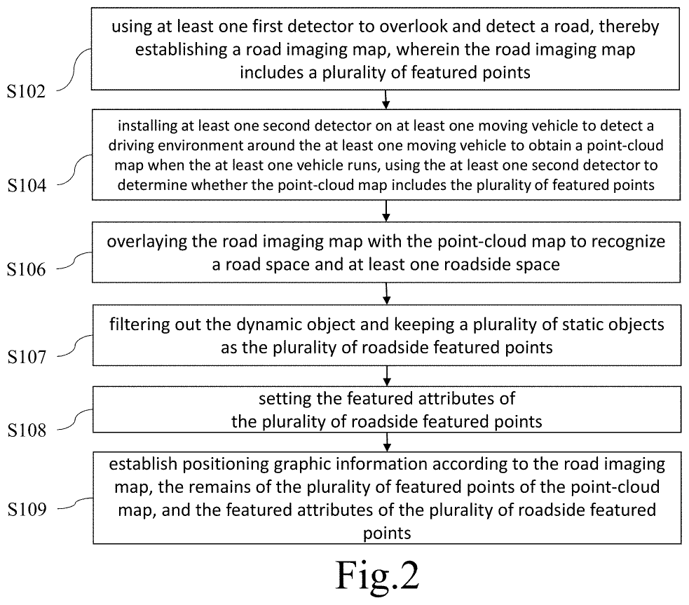

Referring FIG. 2, in Step S102, at least one first detector above a road is used to overlook and detect the road, thereby establishing a road imaging map, wherein the first detector may be an aircraft equipped with an image capturing device. The aircraft may be an uncrewed vehicle, a drone, or a remote control aircraft. The image capturing device may be a photo camera or a video camera. Equipped with a high-resolution image capturing device, the aircraft uses the image capturing device to capture high-precision images. Thus, the road imaging map includes a plurality of featured points, such as dynamic objects and static objects. The dynamic objects include vehicles and pedestrians and the static objects include traffic lights, stop signs, signboards, buildings, and traffic signs. Vehicles in the road space and pedestrians and moving objects in the roadside space are predetermined as the dynamic objects, which are filtered out from the road imaging map. In Step S104, at least one second detector is installed on at least one moving vehicle. The second detector may be a lidar or a camera. The camera uses the stereoscopic imaging technology to generate three-dimensional (3D) images. The moving vehicle may be a car. The second detector detects the driving environment around the moving vehicle to obtain a point-cloud map when the moving vehicle runs. The point-cloud map is established by using the surfaces of the scanned objects to show the shapes of the objects. The high-density point-cloud data can establish a more precise model to form a 3D point-cloud map with depth. The 3D point-cloud map includes the geometric information of the objects to determine whether the geometric information includes the plurality of featured points. Then, in Step 106, the space superposed technology is used to overlay the point-cloud map with the road imaging map to recognize and classify the road space and the roadside space. The roadside space is widely defined. The roadside space, divided into at least two of a sidewalk, a bicycle lane, and the overhang of a storefront from inside to outside, includes a first roadside space and a second roadside space. In Step S107, the dynamic objects of the plurality of featured points are filtered out and the static objects of the plurality of featured points remain as the roadside featured points. In Step S108, the featured attributes of the roadside featured points are set, wherein the featured attributes include the latitudes, longitudes, shapes, sizes, and heights of the roadside featured points. Finally, in Step S109, the positioning graphic information is established according to the superposed map of overlaying the road imaging map with the point-cloud map, the remains (e.g., static objects) of the plurality of featured points of the point-cloud map, and the featured attributes of the roadside featured points.

There is no static object in the roadside space, which represents that no the roadside featured points exist. As a result, the roadside space is directly eliminated and the road space remains, thereby greatly reducing the data volume of the positioning graphic information.

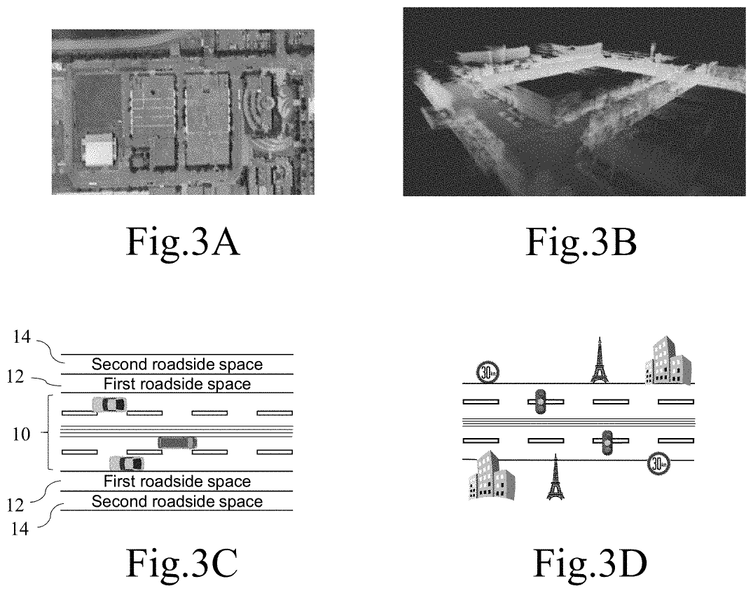

Referring FIGS. 3A, 3B, 3C, and 3D, FIG. 3A is a diagram illustrating a high-precision road imaging map captured from above. The high-precision road imaging map shows which part is a road and which part is not a road (e.g., a building, a park, or a parking lot). As shown in FIG. 3B, a sensor installed on the moving vehicle detects the 3D point-cloud map and uses the position of the moving vehicle and high-precision road geometric spatial information to recognize the plurality of featured points, such as roads, cars, buildings, traffic lights, bus stops, signboards, and traffic signs. The point-cloud map of FIG. 3B is overlaid with the road imaging map of FIG. 3A to form a superposed map, as shown in FIG. 3C. The superposed map is divided into a road space 10 and either a first roadside space 12 or a second roadside space 14. For example, the first roadside space 12 may be a bicycle lane and the second roadside space 14 may be a sidewalk. Alternatively, the first roadside space 12 may be a sidewalk and the second roadside space 14 may include the overhang of a storefront and a building. When the positioning graphic information is established, the dynamic objects such as cars and pedestrians are filtered out since the dynamic objects cannot be used as the roadside featured points. If there is no static object in the second roadside space 14, the second roadside space 14 is also filtered out. The finally-established positioning graphic information is shown in FIG. 3D. The roadside featured points of the road space include traffic lights and the roadside featured points of the roadside space include buildings, electric towers, and traffic signs. Any objects with features may be used as the roadside featured points, such as signboards at convenience stores or fast food restaurants, signboards at gas stations, and so on.

The featured attributes of the roadside featured points depend on different objects. For example, all of the size, height, and shape of a traffic light, a bus stop, and a signboard at a store are recorded in the positioning graphic information.

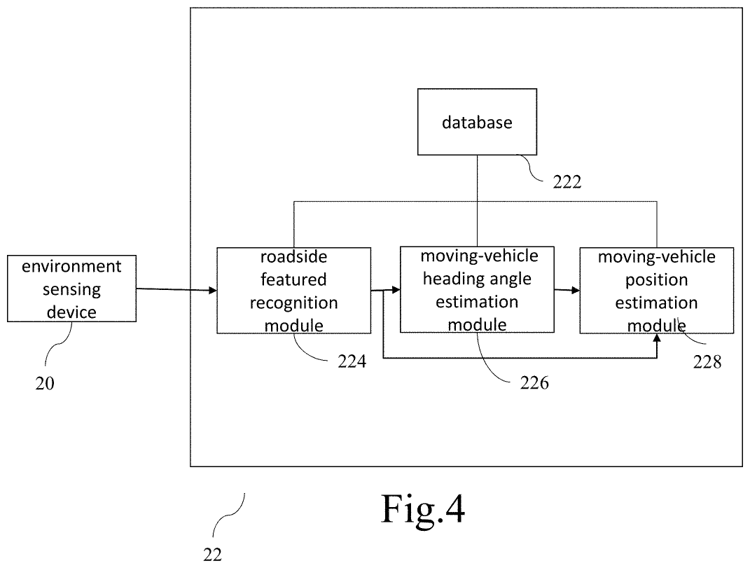

After establishing the positioning graphic information, the positioning graphic information is stored into a cloud platform or a graphic information positioning system of the moving vehicle. The graphic information positioning system periodically updates the latest positioning graphic information from the cloud platform. The graphic information positioning system, installed in an on-board system of the moving vehicle, computes the positioning graphic information to output the position information of the moving vehicle. As shown in FIG. 4, the graphic information positioning system 22 comprises a database 222, a roadside featured recognition module 224, a moving-vehicle heading angle estimation module 226, and a moving-vehicle position estimation module 228. The database 222 is configured to store the positioning graphic information. The positioning graphic information includes the roadside featured points and the featured attributes of the roadside featured points. The moving vehicle further comprises an environment sensing device 20 coupled to the roadside featured recognition module 224 and configured to scan the image of the front road. The environment sensing device 20 transmits the scanned result to the roadside featured recognition module 224. The roadside featured recognition module 224 is coupled to the database 222 and configured to scan the front road and determine whether the scanned image includes the plurality of featured points corresponding to the featured attributes according to the positioning graphic information. If there are at least two of the roadside featured points corresponding to the featured attributes, the roadside featured points corresponding to the featured attributes are used as the reference points. The moving-vehicle heading angle estimation module 226 is coupled to the database 222 and the roadside featured recognition module 224 and configured to calculate the moving-vehicle heading angle based on the reference points. The moving-vehicle position estimation module 228 is coupled to the database 222, the roadside featured recognition module 224, and the moving-vehicle heading angle estimation module 226 and configured to use the moving-vehicle heading angle and the reference points to calculate the position of the moving vehicle.

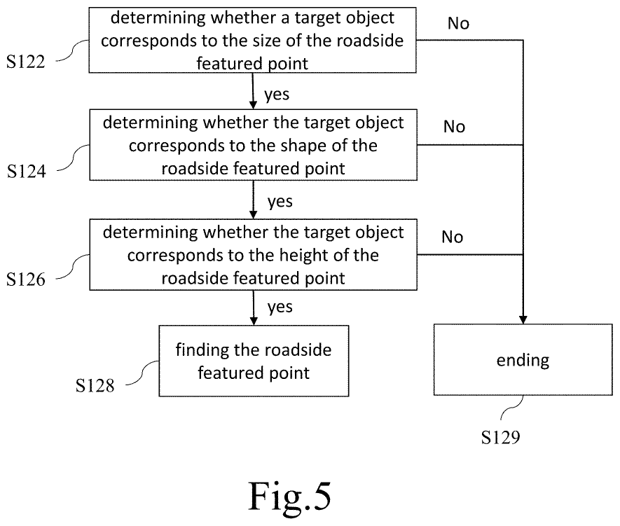

In Step S12 of FIG. 1, a method of recognizing the roadside feature is shown in FIG. 5 when the moving vehicle runs. The environment sensing device 20 installed on the moving vehicle may be a photo camera, a video camera, or a lidar. The environment sensing device 20 retrieves the roadside image in driving, and the processor of the on-board system uses the image-recognizing technology to recognize at least one target object from the roadside image and determines whether the target object is one of the roadside featured points according to the featured attributes of the positioning graphic information. A method of determining whether the target object is one of the roadside featured points comprises: Step S122, Step S124, Step S126, Step S128 and Step S129. Step S122 determines whether the target object corresponds to the size of the roadside featured point. If the answer is yes, the process proceeds to Step S124. Step S124 determines whether the target object corresponds to the shape of the roadside featured point. If the answer is yes, the process proceeds to Step S126. Step S126 determines whether the target object corresponds to the height of the roadside featured points. If the answer is yes, the process proceeds to Step S128. In Step S128, the target object corresponds to one of the roadside featured points, such as a traffic light. If the answer of one of the abovementioned determining steps is no, the process proceeds to Step S129. In Step S129, the process is ended since the target object does not correspond to any of the roadside featured points.

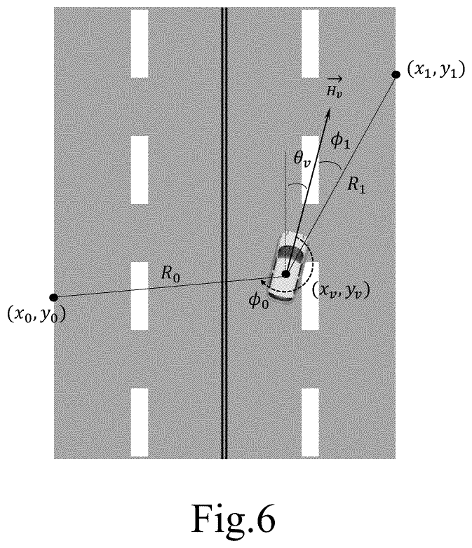

If the heading direction of the moving vehicle is not parallel to the direction of the road, the distance between the moving vehicle and the road is longer and longer when the moving vehicle runs. In order to precisely position the moving vehicle, Step S14 of FIG. 1 uses the technology of calculating the moving-vehicle heading angle. FIG. 6 is a diagram schematically illustrating the heading angle and the position of a moving vehicle according to an embodiment of the present invention. When the moving vehicle runs, the processor of the on-board system determines that at least two of the roadside featured points in front of the moving vehicle are used as the reference points to calculate a moving-vehicle heading angle. Suppose that the coordinate of the moving vehicle is (xᵥ,yᵥ), and the coordinate of the roadside featured point is (x₁,y₁).

xᵥ₁=x₁−R₁ sin(θᵥ+ϕ₁)=x₁−R₁ sin θᵥ cos ϕ₁−R₁ cos θᵥ sin ϕ₁=x₁−(R₁ cos ϕ₁)α−(R₁ sin ϕ₁)β

yᵥ₁=y₁−R₁ sin(θᵥ+ϕ₁)=y₁−R₁ sin θᵥ cos ϕ₁−R₁ cos θᵥ sin ϕ₁=y₁−(R₁ cos ϕ₁)α−(R₁ sin ϕ₁)β

Wherein, α=sin θᵥ, β=cos θᵥ.
Similarly, the coordinate of another roadside featured point is (x₀,y₀) and the coordinate of the moving vehicle is calculated as follows:

xᵥ₀=x₀−(R₀ cos ϕ₀)α−(R₀ sin ϕ₀)β

yᵥ₀=y₀−(R₀ sin ϕ₀)α−(R₀ cos ϕ₀)β

Since xᵥ₀=xᵥ₁ and yᵥ₀=yᵥ₁, Y=HX, wherein X=[α/β]^{T},

$$Y = {[ \begin{matrix}{x}_{0} - {x}_{1} & {y}_{0} - {y}_{1}\end{matrix} ]}^{T} , and$$

$$H = [ \begin{matrix}{R}_{0} cos {φ}_{0} - {R}_{1} cos {φ}_{1} & {R}_{0} sin {φ}_{0} - {R}_{1} sin {φ}_{1} \\ {R}_{1} sin {φ}_{1} - {R}_{0} sin {φ}_{0} & {R}_{0} cos {φ}_{0} - {R}_{1} cos {φ}_{1}\end{matrix} ] .$$

Thus, x=H⁻¹Y.

Since xᵥ₀=xᵥ₁ and yᵥ₀=yᵥ₁, θᵥ is obtained. That is to say, the inclined angle between the heading direction of the moving vehicle and a direction that the moving vehicle straightly runs, namely the moving-vehicle heading angle, is obtained. The triangulation method requires the three reference points to calculate the position of the moving vehicle. The present invention is different from the triangulation method. Based on the calculation process, only required two of the roadside featured points as the reference points can be used to calculate the position of the moving vehicle.

Afterwards, in Step S16 of FIG. 1, the position of the moving vehicle is calculated. The positions of at least two of the moving vehicles are estimated according to the at least two reference points. The formulas of calculating the position of the moving vehicle are described as follows:

$${\hat{x}}_{v} = \frac{{x}_{v 0} + {x}_{v 1}}{2} , {\hat{y}}_{v} = \frac{{y}_{v 0} + {y}_{v 1}}{2}$$

In conclusion, the graphic information positioning system for recognizing roadside features and the method using the same of the present invention use a low-cost aerial photograph to retrieve a high-precision road imaging map, overlay the road imaging map with the point-cloud map established by the driving environment around the vehicle to classify the road space, the roadside space, the dynamic objects, and the static objects, eliminate the dynamic objects and the empty roadside space to greatly reduce the data volume, and require only two roadside featured points as the reference points to calculate the heading angle and the position of the moving vehicle. The present invention has low operation complexity and high reliability. Without using the GPS, the present invention has the precision of centimeters and positions and navigates an autonomous vehicle.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A graphic information positioning method for recognizing roadside features comprising:
using at least one first detector to overlook and detect a road, thereby establishing a road imaging map, wherein the road imaging map includes a plurality of featured points;
installing at least one second detector on at least one moving vehicle to detect a driving environment around the at least one moving vehicle to obtain a point-cloud map when the at least one moving vehicle runs, using the at least one second detector to determine whether the point-cloud map includes the plurality of featured points, filter out at least one dynamic object of the plurality of featured points, set featured attributes of a plurality of roadside featured points, and establish positioning graphic information according to the road imaging map, remains of the plurality of featured points of the point-cloud map, and the featured attributes;
storing the positioning graphic information into the at least one moving vehicle, using a graphic information positioning system installed in the at least one moving vehicle to scan a front road and recognize at least two roadside featured points of the plurality of roadside featured points according to the positioning graphic information when the at least one moving vehicle runs, and using the positioning graphic information to calculate a moving-vehicle heading angle based on the at least two roadside featured points as reference points; and
using the moving-vehicle heading angle and the at least two roadside featured points to calculate a position of the moving vehicle.

2. The graphic information positioning method for recognizing roadside features according to claim 1, wherein the at least one first detector is an aircraft equipped with an image capturing device.

3. The graphic information positioning method for recognizing roadside features according to claim 2, wherein the aircraft is an uncrewed vehicle, a drone, or a remote control aircraft.

4. The graphic information positioning method for recognizing roadside features according to claim 1, wherein the at least one second detector is a lidar, a laser detector, a camera, or a sonar detector.

5. The graphic information positioning method for recognizing roadside features according to claim 1, wherein a method of establishing the positioning graphic information further comprises:
overlaying the road imaging map with the point-cloud map to recognize a road space and at least one roadside space;
filtering out the at least one dynamic object of the plurality of featured points and a plurality of static objects of the plurality of featured points remaining as the plurality of roadside featured points;
setting the featured attributes of the plurality of roadside featured points; and
establishing the positioning graphic information according to a superposed map of overlaying the road imaging map with the point-cloud map, the plurality of roadside featured points, and the featured attributes.

6. The graphic information positioning method for recognizing roadside features according to claim 5, wherein the at least one dynamic object includes cars and pedestrians, and the plurality of static objects include traffic lights, stop signs, signboards, buildings, and traffic signs.

7. The graphic information positioning method for recognizing roadside features according to claim 5, wherein the at least one roadside space, divided into at least two of a sidewalk, a bicycle lane, and an overhang of a storefront from inside to outside, includes a first roadside space and a second roadside space.

8. The graphic information positioning method for recognizing roadside features according to claim 5, wherein the featured attributes include latitudes, longitudes, shapes, sizes, and heights.

9. The graphic information positioning method for recognizing roadside features according to claim 8, wherein the at least one moving vehicle captures a roadside image when the at least one moving vehicle runs, the at least one moving vehicle recognizes at least one target object, and the graphic information positioning system of the at least one moving vehicle determines whether the at least one target object is one of the plurality of roadside featured points according to the featured attributes of the positioning graphic information.

10. The graphic information positioning method for recognizing roadside features according to claim 1, wherein the positioning graphic information is stored in a cloud platform or the graphic information positioning system of the at least one moving vehicle, and the graphic information positioning system is installed in an on-board system of the at least one moving vehicle.

11. A graphic information positioning system, installed in an on-board system of a moving vehicle, positioning the moving vehicle and comprising:
a database storing positioning graphic information, which includes a plurality of roadside featured points and featured attributes of the plurality of roadside featured points;
a roadside featured recognition module scanning a front road and determining at least two roadside featured points of the plurality of roadside featured points corresponding to the featured attributes according to the positioning graphic information;
a moving-vehicle heading angle estimation module calculating a moving-vehicle heading angle based on the at least two roadside featured points as reference points; and
a moving-vehicle position estimation module using the moving-vehicle heading angle and the at least two roadside featured points to calculate a position of the moving vehicle.

12. The graphic information positioning system according to claim 11, wherein the plurality of roadside featured points include traffic lights, stop signs, signboards, buildings, and traffic signs.

13. The graphic information positioning system according to claim 11, wherein the featured attributes include latitudes, longitudes, shapes, sizes, and heights.

14. The graphic information positioning system according to claim 11, wherein the moving vehicle further comprises an environment sensing device scanning an image of the front road.

15. The graphic information positioning system according to claim 11, wherein the environment sensing device is a photo camera, a video camera, or a lidar.
